(19) United States
(12) Patent Application Publication
(10) Pub. No.: US 2022/0343077 A1
(43) Pub. Date: Oct. 27, 2022

(54) METHOD FOR DISPLAYING ENTITY-ASSOCIATED INFORMATION BASED ON ELECTRONIC BOOK AND ELECTRONIC DEVICE

(71) Applicant: ZHANGYUE TECHNOLOGY CO., LTD, Beijing (CN)

(72) Inventors: Ming QIAO, Beijing (CN); Xiaomin WU, Beijing (CN)

(21) Appl. No.: 17/765,809

(22) PCT Filed: Oct. 10, 2020
(86) PCT No.: PCT/CN2020/120163

§ 371 Date: Mar. 31, 2022

(30) Foreign Application Priority Data
Oct. 11, 2019 (CN) 201910964989.0

(51) Int. Cl. G06F 40/295; G06F 16/33; G06F 3/0483

(52) U.S. Cl. CPC G06F 40/295; G06F 16/3334; G06F 3/0483

(57) ABSTRACT

The present disclosure discloses a method for displaying entity-associated information based on an electronic book and an electronic device, and the method includes: determining keywords contained in pages of the electronic book, each of the keywords indicating an entity; displaying a search entrance element corresponding to each of the keywords in the pages, the search entrance element configured to search information associated with the entity; and in response to detecting a search request triggered through the search entrance element, acquiring the information associated with the entity based on the search request and displaying the information associated with the entity.

### CROSS-REFERENCE TO RELATED APPLICATIONS

The present application claims the priority of a Chinese patent application filed with the Chinese Patent Office on Oct. 11, 2019, with the application number of 201910964989.0, and entitle as “METHOD FOR DISPLAYING ENTITY-ASSOCIATED INFORMATION BASED ON ELECTRONIC BOOK AND ELECTRONIC DEVICE”, the entire content of which are incorporated in the present application by reference.

### TECHNICAL FIELD

The present disclosure relates to the field of computers, and in particular to a method for displaying entity-associated information based on an electronic book and an electronic device.

### BACKGROUND

With increase of people's reading consciousness, electronic books have been favored by more and more users. With help of electronic book applications, users can read books on their mobile devices anytime and anywhere. In the prior art, the electronic book applications are mainly used to display the content of electronic books to users through screen terminals, so as to facilitate using terminal devices to read electronic books by the users.

However, the inventor found that the above solution in the prior art has at least the following defects: in the existing applications of electronic books, all text content in pages are displayed in a unified form, which is not good for users to capture key points, and users cannot perform searches associated with content in pages of the electronic book and cannot achieve expansion reading.

### SUMMARY

In view of the above-mentioned problems, the present disclosure provides a method for displaying entity-associated information based on an electronic book and an electronic device that overcome the above-mentioned problems or at least partially solve the above-mentioned problems.

According to an aspect of the present disclosure, a method for displaying entity-associated information based on an electronic book is provided, which includes:

determining keywords contained in pages of the electronic book, each of the keywords indicating an entity;

displaying a search entrance element corresponding to each of the keywords in the pages, the search entrance element configured to search information associated with the entity; and

in response to detecting a search request triggered through the search entrance element, acquiring the information associated with the entity based on the search request and displaying the information associated with the entity.

According to another aspect of the present disclosure, an electronic device is provided, which includes: a processor, a memory, a communication interface and a communication bus, wherein the processor, the memory and the communication interface communicate with each other through the communication bus;

the memory is configured to store at least one executable instruction, which causes the processor to perform the following operations:

determining keywords contained in pages of the electronic book, each of the keywords indicating an entity;

displaying a search entrance element corresponding to each of the keywords in the pages, the search entrance element configured to search information associated with the entity; and

in response to detecting a search request triggered through the search entrance element, acquiring the information associated with the entity based on the search request and displaying the information associated with the entity.

According to further another aspect of the present disclosure, a non-volatile computer-readable storage medium is provided, in which at least one executable instruction is stored, wherein the executable instruction causes a processor to perform the following operations:

determining keywords contained in pages of the electronic book, each of the keywords indicating an entity;

displaying a search entrance element corresponding to each of the keywords in the pages, the search entrance element configured to search information associated with the entity; and

in response to detecting a search request triggered through the search entrance element, acquiring the information associated with the entity based on the search request and displaying the information associated with the entity.

According to yet another aspect of the present disclosure, a computer program product is provided, which includes a calculation program stored on the above non-volatile computer-readable storage medium.

In the method for displaying entity-associated information based on an electronic book and the electronic device provided by the present disclosure, the keywords contained in pages of the electronic book can be determined, and the search entrance element corresponding to each of the keywords in the pages can be displayed, and correspondingly according to the detected search request triggered through the search entrance element, information associated with the entity based on the search request can be displayed. It can thus be seen that, in this way, on the one hand, the keywords in the pages of the electronic book can be recognized and the corresponding search entrance element can be displayed, so that it is facilitated to capture key content represented by the keywords by the user; on the other hand, a search can be performed based on the search entrance element, so that extended reading by the user is facilitated and reading efficiency is improved.

The above explanation is only an overview of the technical solutions of the present disclosure. In order to enable clearer understanding of the technical means of the present disclosure, so that they can be implemented in accordance with the content of the specification, and in order to make the above and other objectives, features and advantages of the present disclosure more obvious and understandable, specific embodiments of the present disclosure are specifically exemplified in the following.

### BRIEF DESCRIPTION OF THE DRAWINGS

By reading the detailed description of the embodiments below, various other advantages and benefits will become clearer to those of ordinary skill in the art. The drawings are only used for the purpose of illustrating the embodiments, and are not considered as a limitation to the present disclosure. Also, throughout the drawings, the same reference symbols are used to denote the same components. In the drawings:

FIG. 1 shows a flowchart of a method for displaying entity-associated information based on an electronic book provided by one embodiment of the present disclosure;

FIG. 2 shows a flowchart of a method for displaying entity-associated information based on an electronic book provided by another embodiment of the present disclosure;

FIG. 3 shows a schematic structural diagram of an electronic device according to another embodiment of the present disclosure.

### DETAILED DESCRIPTION

Hereinafter, exemplary embodiments of the present disclosure will be described in more detail with reference to the accompanying drawings. Although the exemplary embodiments of the present disclosure are shown in the drawings, it should be understood that the present disclosure can be implemented in various forms and should not be limited by the embodiments set forth herein. On the contrary, these embodiments are provided in order to enable a more thorough understanding of the present disclosure and to fully convey the scope of the present disclosure to those skilled in the art.

### Embodiment 1

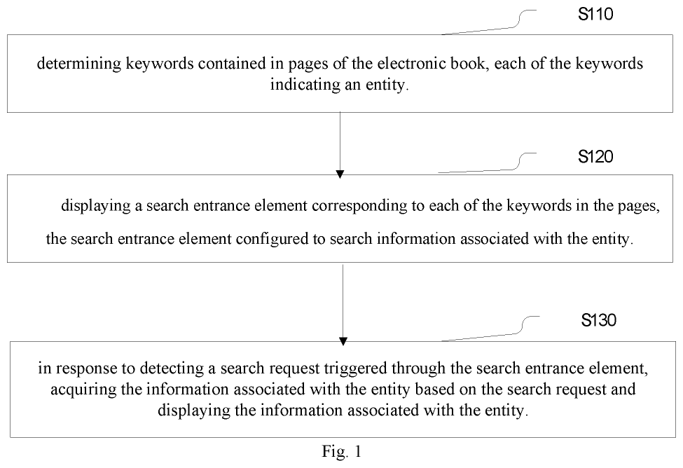

FIG. 1 shows a flowchart of a method for displaying entity-associated information based on an electronic book provided by one embodiment of the present disclosure. As shown in FIG. 1, the method includes the following steps.

A step S110: determining keywords contained in pages of the electronic book, each of the keywords indicating an entity.

The keywords refers to words that are nouns and are used to indicate entities. The keywords may include for example, names of persons, names of organizations, names of places and names of all other entities identified by the names, and may even also include entity words of various nouns, such as numbers, dates, currencies, addresses and events. In short, any nouns that can refer to specific things can be used as the keywords in the present embodiment.

Specifically, the keywords contained in the pages of the electronic book can be determined flexibly through a variety of ways. For example, the keywords contained in the pages of the electronic book may be recognized by means of semantic recognition, and the keywords contained in the pages of the electronic book may also be recognized with reference to such as content of comments, annotation information and the like fed back by a user. All in all, the present disclosure does not limit the specific method for determining the keywords.

A step S120: displaying a search entrance element corresponding to each of the keywords in the pages, the search entrance element configured to search information associated with the entity.

In order to facilitate capturing key content of the pages of the electronic book by the user, and also to facilitate extended reading by the user by means of related search, a search entrance element are set for each of the keywords in the pages. the form of the search entrance element can be flexibly set by those skilled in the art, which will not be limited in the present disclosure. For example, the search entrance element may be in various forms such as a hyperlink, a search button and the like.

A step S130: in response to detecting a search request triggered through the search entrance element, acquiring the information associated with the entity based on the search request and displaying the information associated with the entity.

Specifically, the search request can be triggered through the search entrance element. Accordingly, when the search request triggered through the search entrance element is detected, the information associated with the entity based on the search request will be acquired, and the acquired information associated with the entity will be displayed to the user. In specific implementation, it needs to determine the information associated with the entity based on the search request according identification information contained in the search request for identifying a keyword, wherein the information associated with the entity is content which has a preset association relationship with the keyword, and for example may be the name of the electronic book containing the keyword, a highlight paragraph containing the keyword and the like. The present disclosure does not limit the specific connotation of the information associated with the entity, as long as the purpose of extended reading can be achieved.

As can thus be seen that, in the method for displaying entity-associated information based on an electronic book provided by the present disclosure, the keywords contained in pages of the electronic book can be determined, and the search entrance element corresponding to each of the keywords in the pages can be displayed, and correspondingly according to the detected search request triggered through the search entrance element, information associated with the entity based on the search request can be displayed. It can thus be seen that, in this way, on the one hand, the keywords in the pages of the electronic book can be recognized and the corresponding search entrance element can be displayed, so that it is facilitated to capture key content represented by the keywords by the user; on the other hand, a search can be performed based on the search entrance element, so that extended reading by the user is facilitated and reading efficiency is improved.

### Embodiment 2

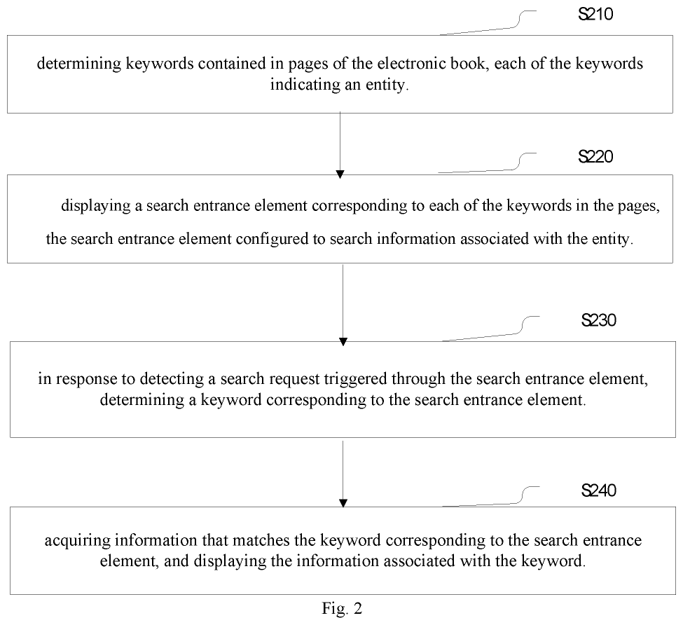

FIG. 2 shows a flowchart of a method for displaying entity-associated information based on an electronic book provided by another embodiment of the present disclosure. As shown in FIG. 2, the method includes the following steps.

A step S210: determining keywords contained in pages of the electronic book, each of the keywords indicating an entity.

Specifically, in the present embodiment, the keywords contained in original text of the electronic book are recognized beforehand, and corresponding offset amount information of each of the keywords in the electronic book is determined. Performing recognition of the original text of the electronic book beforehand is beneficial to improve subsequent display speed. Of course, in other embodiments of the present disclosure, the keywords contained in pages of the electronic book may also be recognized in real time in the reading process of the electronic book, and the present disclosure does not limit timing of recognition of the keywords.

In specific implementation, the keywords may be recognized in the following way.

Firstly, each of words contained in the original text of the electronic book and an initial word vector corresponding to each of the words are acquired, and each of word segmentations contained in the original text of the electronic book and an initial phrase vector corresponding to each of the word segmentations are acquired. Specifically, word cutting processing is performed on the original text of the electronic book to obtain each of words contained in the original text and the initial word vector corresponding to each of the words. In the present disclosure, not only a corresponding initial word vector may be determined for each word obtained after word cutting, but also each of the words obtained after word cutting may be selected first and a corresponding initial word vector may be determined only for a word obtained after selecting. For example, a word having specific meanings may be selected in accordance with literal meanings of the word and a word used as an auxiliary word and a modal particle may be filtered, thereby simplifying the amount of subsequent data. The initial word vectors corresponding to each of the words contained in the original text may be determined directly based on a word vector dictionary. Since the present embodiment is used for performing recognition for the text of the electronic book, the word vector dictionary may be generated based on a bookstore database of an electronic book application. First, the text content of the respective electronic books contained in the bookstore database of the electronic book application is acquired in advance, and original corpus data is generated based on the text content of the respective electronic books. It can thus be seen that the original corpus data in the present embodiment is generated based on the texts of the respective electronic books in the bookstore database of the electronic book application, which can reflect writing characteristics of the texts of the electronic books and is beneficial to improve accuracy of word vectors and phrase vectors, thereby improving the accuracy of the recognition. Then, the word vector dictionary corresponding to the original corpus data is determined through at least one kind of a first vector model and a second vector model, so that the initial word vector corresponding to each of the words will be determined based on the word vector dictionary. The first vector model and the second vector model are both used to generate word vectors, and the two can be used separately or in combination. The first vector model may be the word2vector model, and the second vector model may be the Glove model. Both of the above-mentioned vector models can realize the vectorized representation of a single word, so that each of the words can be described in the form of vector so as to facilitate subsequent analysis and processing. The initial word vector in the present embodiment may be a 64-dimensional vector. Similarly, when determining each of the word segmentations contained in the original text and the initial phrase vectors corresponding to each of the word segmentations, word segmentation processing is performed on the original text based on a word segmentation dictionary to obtain each of the word segmentations contained in the original text and the initial phrase vector corresponding to each of word segmentations. In the present disclosure, not only corresponding initial phrase vector can be determined for each word obtained after word segmentation, but also each of the words obtained after word segmentation can be selected first and the corresponding initial phrase vectors can be determined only for a word obtained after selecting. For example, a word with clear meanings such as nouns, adjectives and the like can be selected based on its part of speech, and a word without clear meanings such as an auxiliary word, a modal particle, an adverb and the like can be filtered, thereby simplifying the amount of subsequent data. The initial phrase vectors corresponding to each of the word segmentations contained in the original text can be determined directly based on a phrase vector dictionary. The method for generating the phrase vector dictionary is similar to the method for generating the word vector dictionary, and will not be repeated here. The initial phrase vector in the present embodiment may be a 128-dimensional vector.

Then a semantic word vector corresponding to each of the words is determined based on the initial word vector corresponding to each of the words and context information of each corresponding word in the original text; and a semantic phrase vector corresponding to each of the word segmentations is determined based on the initial phrase vector corresponding to each of the word segmentations and context information of each corresponding word segmentation in the original text. Specifically, based on position information of each of the words or word segmentations in the original text, context information of each of the words or word segmentations in the original text can be determined, so that semantic word vectors or semantic phrase vectors incorporating semantic content of the context information will be obtained. In specific implementation, based on a preset training model, semantic association relationship between the initial word vector corresponding to each of the words and the context information of each corresponding word in the original text is determined to obtain the semantic word vector corresponding to each of the words; and based on the preset training model, semantic association relationship between the initial phrase vector corresponding to each of the word segmentations and the context information of each corresponding word segmentation in the original text is determined to obtain the semantic phrase vector of each of the word segmentations; and the semantic word vector and the semantic phrase vector are vectors obtained after the context information is incorporated. When determining the semantic word vector of a target word, firstly, based on offset amount of the target word in the original text, relative offset amounts of other words (i.e., non-target words) in the original text with respect to the target word will be determined, and then based on the relative offset amounts of the respective non-target words with respect to the target word, the semantic word vector of the target word will be generated, thereby incorporating the context information of the target word. The method for determining the semantic phrase vector is similar to that of the semantic word vector, and both are determined in conjunction with the context information of the word segmentations.

Next, a first entity recognition result based on semantic word vectors corresponding to the words, and a second entity recognition result based on semantic phrase vectors corresponding to the word segmentations are determined. In specific implementation, the semantic word vector corresponding to each of the words is input into a word segmentation marking model to obtain the first entity recognition result based on the semantic word vector corresponding to each of the words; and the semantic phrase vector corresponding to each of the word segmentations is input into a word segmentation marking model to obtain the second entity recognition result corresponding to the semantic phrase vector corresponding to each of the word segmentations. The word segmentation marking model is used to perform entity annotation processing based on the semantic vectors, and specifically may be a variety of marking models. In the present embodiment, the word segmentation marking model is a conditional random field model (CRF model for short), which can perform part-of-speech annotation based on a statistical method so as to recognize the keywords. Specifically, in the present embodiment, on the one hand, the first entity recognition result based on the semantic word vectors corresponding to the words is obtained based on the word segmentation marking model; on the other hand, the second entity recognition result based on the semantic phrase vectors corresponding to the word segmentations is obtained based on the word segmentation marking model. The word segmentation marking model used to obtain the first entity recognition result and the word segmentation marking model used to obtain the second entity recognition result may be the same or different, as long as the part-of-speech annotation processing can be implemented. It can thus be seen that the first processing procedure of obtaining the first entity recognition result based on the semantic word vectors corresponding to the words based on the word segmentation marking model is carried out independently of the second processing procedure of obtaining the second entity recognition result based on the semantic phrase vectors corresponding to the word segmentations based on the word segmentation marking model, and the two do not affect each other. The sequence of the first processing procedure and the second processing procedure is not limited by the present disclosure, and the two can be performed simultaneously or sequentially. In a word, the core of the present embodiment lies in that: two sets of recognition results will be obtained independently through two sets of mutually parallel processing procedures of the first processing procedure based on the semantic word vectors and the second processing procedure based on the semantic phrase vectors, thereby achieving the effect of learning from each other.

Finally, the keywords contained in the original text are recognized based on the first entity recognition result and the second entity recognition result. Specifically, the first entity recognition result is compared with the second entity recognition result, and at least one of the first entity recognition result and the second entity recognition result is modified based on the comparison result to recognize the keywords contained in the original text. For example, the first entity recognition result and the second entity recognition result are subjected to DIFF operation processing to compare similarities and differences between the two, and the keywords contained in the original text are recognized based on the comparison result. Optionally, when the recognized keywords are not stored in the word segmentation dictionary, the recognized keywords can be added into the word segmentation dictionary. This method can take full advantages of the flexibility of the word vectors and the large amount of information of the phrase vectors, so that the advantages of the two can be used to obtain accurate recognition results, which not only avoids inaccurate recognition caused by the small amount of information of the word vectors, but also avoids errors of recognition caused by errors of word segmentation, so that the accuracy of the recognition results can be significantly improved. Moreover, this method can automatically discover emerging vocabulary, thereby expanding the word segmentation dictionary, and then optimizing the subsequent recognition process.

It can thus be seen that the keywords contained in the pages of the electronic book can be accurately recognized through the above method. In addition, the inventor found in the process of implementing the present disclosure that, for keywords of person name type, there may be words corresponding to virtual persons, or there may be some words that are similar to person names but actually not person names. In order to prevent misrecognition caused by the above factors, in the present step, the following processing is further performed: acquiring, for a recognized keyword, in response to determining that a recognized keyword is a person name type of keyword, a person search result corresponding to the recognized keyword is acquired; it is determined whether the person search result contains birth and death date information; the person name type of keyword is remained when the person search result contains the birth and death date information; and the person name type of keyword is deleted when the person search result does not contain the birth and death date information. For example, for a keyword with person name type, a person search result corresponding to the keyword may be acquired through search engines such as Baidu and the like, and the person search result may be used to introduce the person's life; and it may be determined whether the person search result contains content that matches information format of birth and death date information, for example, the information format of the birth and death date information may be fixed as XXXX year XX month XX day, wherein X represents Arabic numerals. Since a real person must have birth and death information (at least birth information), misrecognized keywords of person name type can be eliminated through the above-mentioned method and the accuracy of the recognition results can be improved. Moreover, since in actual situations, most of the people names that users want to know are well-known people with certain influence, the needs of the users can be met through the above-mentioned processing.

In addition, for the recognized the keywords of place name type, considering that most users are often not interested in place names that are familiar to everyone, and users want to know some more specific place names, correspondingly, in the present embodiment, common place names such as Beijing and Shanghai can be further eliminated through a preset general place name list, or common place names can be eliminated based on frequency of occurrence of the recognized place names in the bookstore database of the electronic book application, to ensure that the finally obtained keywords are specific place names, such as Linyi, Huguosi, etc.

A step S220: displaying a search entrance element corresponding to each of the keywords in the pages, the search entrance element configured to search information associated with the entity.

Specifically, since each of the keywords contained in the pages of the electronic book have been recognized in the previous step, correspondingly, in the present step, it needs to further display the search entrance element corresponding to each of the recognized keywords in the pages of the electronic book. The search entrance element may be of many forms.

In a specific implementation, annotation processing on each of the keywords is performed according to annotation information, the annotation information is displayed as the search entrance element corresponding to each of the keywords, and the annotation processing comprises at least one of: highlighting, adding an underline, or adding a hyperlink, wherein the underline comprises a solid line and a dashed line The annotation information is used to define associated information used in the annotation processing, such as line type, thickness, color and the like. Specifically, after the keywords contained in the pages of the electronic book are recognized, the recognized keywords are passed to a page typesetting engine, and the page typesetting engine traverses content to be typeset to determine the each of the keywords contained in the content to be typeset and the corresponding offset amount information of each of the keywords in the electronic book. The offset amount information is used to indicate typeset positions of the keywords in the electronic book, so as to facilitate rapid positioning of the keywords. Correspondingly, for each of the keywords obtained by traversal, the page typesetting engine further sets corresponding annotation information based on an attribute corresponding to each of the keywords, so as to facilitate rendering and presenting the search entrance element of each of the keywords based on the annotation information set by the page typesetting engine. The annotation information of the keywords may be the same or different. In an optional manner, all the annotation information of the keywords may be set as the dashed-line type annotation attribute of the same line type. In yet another optional manner, different annotation information may be set based on information such as types of the keywords, frequencies of appearance in the electronic book, user interaction data and the like. The latter method helps to set more eye-catching annotation information for content that are of high importance and that users are more interested in. For example, based on a type of a keyword, the annotation information corresponding to that type may be set, so as to facilitate quickly distinguishing different types of keywords and selecting a keyword of the type that the user is interested in based on the annotation information by users. For another example, it is also possible to classify the keywords into classes based on the frequencies of occurrence of each of the keywords in the electronic book and the user interaction data generated for the keyword, so as to, for the keywords of different classes, set annotation information corresponding to a class, and to facilitate quickly distinguishing keywords of different classes based on the annotation information by users. The user interaction data generated for the keywords may include data of a plurality of interaction types, and different type weights may be set for different interaction types, so as to classify based on the number of interactions and type weights in the interaction data. For example, interaction weights of interaction types such as comment and note are greater than the interaction weight of interaction type such as line, which is beneficial to highlighting the content that the user is interested in.

A step S230: in response to detecting a search request triggered through the search entrance element, determining a keyword corresponding to the search entrance element.

Specifically, the user may trigger the search request through various types of interactive operations on the search entrance element such as clicking and sliding. In response to detecting a search request triggered through the search entrance element, a keyword corresponding to the search entrance element needs to be determined. There may be a plurality of kinds of specific determination methods. For example, in one way, for a search entrance element, element identification for uniquely identifying the search entrance element may be set, and the element identification and the keyword corresponding thereto may be associated and stored in a preset query list, and accordingly based on the element identification contained in the received search request, the corresponding keyword may be queried.

In the present embodiment, since the corresponding offset amount information of each of the keywords in the electronic book is determined in advance, in the present step, the offset amount information associated with text content of the search entrance element is determined, and a keyword corresponding to the search entrance element is determined based on the offset amount information. Since the search entrance elements matches positions of the keywords and are usually located below the keywords, the offset amount information of a corresponding keyword can be determined based on the offset amount information associated with the text content of the search entrance element, and accordingly, based on the pre-stored corresponding offset amount information of the each of the keywords in the electronic book, the keyword corresponding to a received search request can be quickly determined.

A step S240: acquiring information that matches the keyword corresponding to the search entrance element, and displaying the information associated with the keyword.

The information that matches the keyword is used to implement extended reading, and may specifically be various types of content that have an association relationship with the keyword.

In an alternative implementation, the information associated with the entity may be a book type of information associated with the keyword, and correspondingly when acquiring the information associated with the entity that matches the keyword, an electronic book associated with the keyword from electronic books contained in a database is selected based on at least one of: a number of occurrences of the keyword in each of the electronic books or user interaction data associated with each of the electronic books; and the book type of information that matches the keyword is determined based on the selected electronic book.

In this method, an electronic book associated with the current electronic book being read may be displayed to the user by the information associated with the entity, so as to facilitate extended reading by the user. Specifically, the number of occurrences of the keyword in each of the electronic books may be counted, and an electronic book with a larger number of occurrences of the keyword may be determined as the electronic book associated with the current electronic book being read. In addition, it is also possible to select an electronic book associated with the target electronic book from the electronic books contained in the database based on the user interaction data associated with each of the electronic books. For example, the user interaction data, such as user comments, user notes, user sharing, user marking, etc., of the each of the keywords in the electronic books may be counted, and the electronic book with keywords with a larger number of interactions or with an interaction type belonging to preset types (such as comment type or note type) may be determined as an electronic book associated with the current electronic book being read. For example, knowledge chain related to the keyword may be displayed, and introduction information of the electronic books associated with the target electronic book and paragraphs in the electronic book associated with the target electronic book corresponding to the keyword may be displayed in the knowledge chain.

In yet another alternative implementation, the information associated with the entity may be a chapter and paragraph type of information, and correspondingly when acquiring the information associated with the entity that matches the keyword, a chapter or paragraph from chapters or paragraphs of the current electronic book can be selected based on at least one of: a number of occurrences of the keyword in the chapters of the current electronic book, a number of occurrences of the keyword in the paragraphs of the current electronic book, user interaction data associated with each of the chapters, or user interaction data associated with each of the paragraphs.

Similar to the previous method, in this method, chapter and paragraph type of information associated with the current electronic book being read may be displayed to the user by the information associated with the entity, so as to facilitate extended reading by user. Specifically, the number of occurrences of the keyword in the chapters or paragraphs in the current electronic book may be counted, and a chapter or paragraph with a larger number of occurrences of the keyword may be determined as the chapter and paragraph type of information that matches the keyword. In addition, it is also possible to select a chapter or paragraph from chapters or paragraphs of the current electronic book based on the user interaction associated with each of the chapters or paragraphs. For example, the user interaction data, such as user comments, user notes, user sharing, user marking, etc., of the each of the keywords in the chapters or paragraphs may be counted, and the chapter or paragraph with the keyword with a larger number of interactions or with an interaction type belonging to preset types (such as comment type or note type) may be determined as the chapter and paragraph type of information. For example, the appearance record corresponding to the keyword may be displayed, so that the chapters and paragraphs containing the keyword may be displayed in order in accordance with the chapter order, so as to facilitate focusing on understanding the meaning of the keyword by the user.

The above two methods may be used separately or in combination. In addition, when displaying, the associated result page can be overlaid on the pages of the electronic book of the electronic book in the form of a floating layer, so as to display the information associated with the entity in the association result page.

In addition, the inventor discovered in the process of implementing the present disclosure that the pages of the electronic book may also contain other types of interaction elements, and the response areas of the search entrance elements may partially overlap with the response areas of other types of interaction elements. At this time, in order to distinguish the type of interaction request triggered by the user, a response priority needs to be set for the search entrance element. Optionally, in the present embodiment, the response priority of the search entrance element is lower than the response priority of a preset interaction element; correspondingly, in response to detecting an interaction event that corresponds to the search entrance element, it is determined whether there is an overlap area between the search entrance element and the preset interaction element; the search request is triggered in response to determining that there is no overlap area between the search entrance element and the preset interaction element, and an interaction request corresponding to the preset interaction element is triggered in response to determining that there is the overlap area between the search entrance element and the present interaction element. The preset interaction element includes: a line-type interaction element or a note-type interaction element for marking important contents. For example, when an interaction event that corresponds to the search entrance element is detected, a touch-control position corresponding to this interaction event may be determined and it may be determined whether there is an overlap between the touch-control position and the response area of the preset interaction element, and if there is an overlap between the touch-control position and the response area of the preset interaction element, a line-type interaction operation or a note-type interaction operation will be performed corresponding to the preset interaction element. In this way, it can be ensured that other interaction operations of the user will not be interfered by the search entrance elements, thereby preventing misoperation of the user.

In summary, in the present embodiment, the keywords contained in pages of the electronic book can be recognized and the search entrance element corresponding to each of the keywords in the pages can be displayed, therefore facilitating by users capture of key content represented by the keywords; and searches can be performed based on search entrance elements, so that extended reading by users is are facilitated and improve reading efficiency. The information associated with the entity may be either electronic book information or paragraph information. Since the information associated with the entity contains the keywords, it helps users to comprehensively understand the relevant content of the keywords and helps to improve reading effects.

### Embodiment 3

An embodiment of the present application provides a non-volatile computer-readable storage medium, in which at least one executable instruction is stored, wherein the computer-executable instruction can execute the method for displaying entity-associated information based on an electronic book in any of the foregoing method embodiments.

The executable instruction is specifically configured to cause a processor to execute the following operation:

determining keywords contained in pages of the electronic book, each of the keywords indicating an entity;

displaying a search entrance element corresponding to each of the keywords in the pages, the search entrance element configured to search information associated with the entity; and

in response to detecting a search request triggered through the search entrance element, acquiring the information associated with the entity based on the search request and displaying the information associated with the entity.

In an alternative implementation, the executable instruction causes the processor to perform the following operations:

recognizing the keywords contained in original text of the electronic book;

determining corresponding offset amount information of each of the keywords in the electronic book;

determining offset amount information associated with text content of the search entrance element, and determining a keyword corresponding to the search entrance element based on the offset amount information associated with the text content of the search entrance element; and

acquiring information that matches the keyword corresponding to the search entrance element, and displaying the information associated with the keyword.

In an alternative implementation, the information associated with the entity comprises a book type of information associated with the keyword, and the executable instruction causes the processor to perform the following operations:

selecting an electronic book associated with the keyword from electronic books contained in a database based on at least one of: a number of occurrences of the keyword in each of the electronic books or user interaction data associated with each of the electronic books; and

determining the book type of information that matches the keyword based on the selected electronic book.

In an alternative implementation, the information associated with the entity comprises a chapter and paragraph type of information, and the executable instruction causes the processor to perform the following operations:

selecting a chapter or paragraph from chapters or paragraphs of the current electronic book based on at least one of: a number of occurrences of the keyword in the chapters of the current electronic book, a number of occurrences of the keyword in the paragraphs of the current electronic book, user interaction data associated with each of the chapters, or user interaction data associated with each of the paragraphs; and

determining the chapter and paragraph type of information that matches the keyword based on the selected chapter or selected paragraph.

In an alternative implementation, the executable instruction causes the processor to perform the following operations:

acquiring each of words contained in the original text of the electronic book and an initial word vector corresponding to each of the words, and acquiring each of word segmentations contained in the original text of the electronic book and an initial phrase vector corresponding to each of the word segmentations;

determining a semantic word vector corresponding to each of the words based on the initial word vector corresponding to each of the words and context information of each corresponding word in the original text; and determining a semantic phrase vector corresponding to each of the word segmentations based on the initial phrase vector corresponding to each of the word segmentations and context information of each corresponding word segmentation in the original text;

determining a first entity recognition result based on semantic word vectors corresponding to the words, and determining a second entity recognition result based on semantic phrase vectors corresponding to the word segmentations; and

recognizing the keywords contained in the original text based on the first entity recognition result and the second entity recognition result.

In an alternative implementation, the executable instruction causes the processor to perform the following operations:

in response to determining that a recognized keyword is a person name type of keyword, acquiring a person search result corresponding to the recognized keyword;

determining whether the person search result contains birth and death date information;

remaining the person name type of keyword when the person search result contains the birth and death date information; and

deleting the person name type of keyword when the person search result does not contain the birth and death date information.

In an alternative implementation, the executable instruction causes the processor to perform the following operations:

performing annotation processing on each of the keywords according to annotation information, wherein the annotation information is displayed as the search entrance element corresponding to each of the keywords;

wherein the annotation processing comprises at least one of: highlighting, adding an underline, or adding a hyperlink, wherein the underline comprises a solid line and a dashed line.

In an alternative implementation, a response priority of the search entrance element is lower than a response priority of a preset interaction element, and wherein the preset interaction element comprises a line-type interaction element;

then the executable instruction causes the processor to perform the following operations:

in response to detecting an interaction event that corresponds to the search entrance element, determining whether there is an overlap area between the search entrance element and the preset interaction element;

triggering the search request in response to determining that there is no overlap area between the search entrance element and the preset interaction element, and

triggering an interaction request corresponding to the preset interaction element in response to determining that there is the overlap area between the search entrance element and the present interaction element.

### Embodiment 4

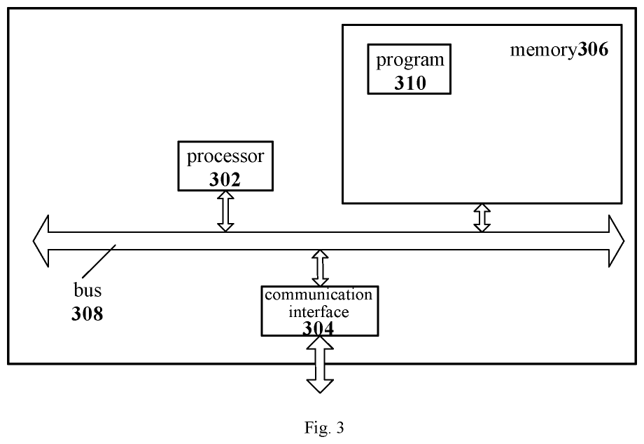

FIG. 3 shows a schematic structural diagram of an electronic device according to another embodiment of the present disclosure, and the specific embodiment of the present disclosure does not limit the specific implementation of the electronic device.

As shown in FIG. 3, the electronic device may include: a processor 302, a communication interface 304, a memory 306 and a communication bus 308.

Wherein: The processor 302, the communication interface 304 and the memory 306 communicate with each other through the communication bus 308. The communication interface 304 is configured to communicate with other devices such as network elements such as clients or other servers. The processor 302 is configured to execute a program 310, and specifically can execute the relevant steps in the embodiments of the above described method for displaying entity-associated information based on an electronic book.

Specifically, the program 310 may include a program code, which includes a computer operation instruction.

The processor 302 may be a central processing unit CPU, or an Application Specific Integrated Circuit (ASIC), or one or more integrated circuits configured to implement the embodiments of the present disclosure. The one or more processors included in the electronic device may be the same type of processor, such as one or more CPUs, or may also be different types of processors, such as one or more CPUs and one or more ASICs.

The memory 306 is configured to store the program 310. The memory 306 may include a high-speed RAM memory, and may also include a non-volatile memory such as at least one disk memory.

The program 310 may be specifically configured to enable the processor 302 to perform the following operations:

determining keywords contained in pages of the electronic book, each of the keywords indicating an entity;

displaying a search entrance element corresponding to each of the keywords in the pages, the search entrance element configured to search information associated with the entity; and

in response to detecting a search request triggered through the search entrance element, acquiring the information associated with the entity based on the search request and displaying the information associated with the entity.

In an alternative implementation, the executable instruction causes the processor to perform the following operations:

recognizing the keywords contained in original text of the electronic book;

determining corresponding offset amount information of each of the keywords in the electronic book;

determining offset amount information associated with text content of the search entrance element, and determining a keyword corresponding to the search entrance element based on the offset amount information associated with the text content of the search entrance element; and

acquiring information that matches the keyword corresponding to the search entrance element, and displaying the information associated with the keyword.

In an alternative implementation, the information associated with the entity comprises a book type of information associated with the keyword, and the executable instruction causes the processor to perform the following operations:

selecting an electronic book associated with the keyword from electronic books contained in a database based on at least one of: a number of occurrences of the keyword in each of the electronic books or user interaction data associated with each of the electronic books; and

determining the book type of information that matches the keyword based on the selected electronic book.

In an alternative implementation, the information associated with the entity comprises a chapter and paragraph type of information, and the executable instruction causes the processor to perform the following operations:

selecting a chapter or paragraph from chapters or paragraphs of the current electronic book based on at least one of: a number of occurrences of the keyword in the chapters of the current electronic book, a number of occurrences of the keyword in the paragraphs of the current electronic book, user interaction data associated with each of the chapters, or user interaction data associated with each of the paragraphs; and

determining the chapter and paragraph type of information that matches the keyword based on the selected chapter or selected paragraph.

In an alternative implementation, the executable instruction causes the processor to perform the following operations:

acquiring each of words contained in the original text of the electronic book and an initial word vector corresponding to each of the words, and acquiring each of word segmentations contained in the original text of the electronic book and an initial phrase vector corresponding to each of the word segmentations;

determining a semantic word vector corresponding to each of the words based on the initial word vector corresponding to each of the words and context information of each corresponding word in the original text; and determining a semantic phrase vector corresponding to each of the word segmentations based on the initial phrase vector corresponding to each of the word segmentations and context information of each corresponding word segmentation in the original text;

determining a first entity recognition result based on semantic word vectors corresponding to the words, and determining a second entity recognition result based on semantic phrase vectors corresponding to the word segmentations; and

recognizing the keywords contained in the original text based on the first entity recognition result and the second entity recognition result.

In an alternative implementation, the executable instruction causes the processor to perform the following operations:

in response to determining that a recognized keyword is a person name type of keyword, acquiring a person search result corresponding to the recognized keyword;

determining whether the person search result contains birth and death date information;

remaining the person name type of keyword when the person search result contains the birth and death date information; and

deleting the person name type of keyword when the person search result does not contain the birth and death date information.

In an alternative implementation, the executable instruction causes the processor to perform the following operations:

performing annotation processing on each of the keywords according to annotation information, wherein the annotation information is displayed as the search entrance element corresponding to each of the keywords;

wherein the annotation processing comprises at least one of: highlighting, adding an underline, or adding a hyperlink, wherein the underline comprises a solid line and a dashed line.

In an alternative implementation, a response priority of the search entrance element is lower than a response priority of a preset interaction element, and wherein the preset interaction element comprises a line-type interaction element;

then the executable instruction causes the processor to perform the following operations:

in response to detecting an interaction event that corresponds to the search entrance element, determining whether there is an overlap area between the search entrance element and the preset interaction element;

triggering the search request in response to determining that there is no overlap area between the search entrance element and the preset interaction element, and

triggering an interaction request corresponding to the preset interaction element in response to determining that there is the overlap area between the search entrance element and the present interaction element.

The algorithms and displays provided here are not inherently related to any particular computer, virtual system or other equipment. Various general-purpose systems can also be used with the teaching based on this. Based on the above description, the structure required to construct this type of system is obvious. In addition, the present disclosure is not directed to any specific programming language. It should be understood that various programming languages can be used to implement the content of the present disclosure described herein, and the above description of a specific language is for the purpose of disclosing the best embodiment of the present disclosure.

In the specification provided here, a lot of specific details are explained. However, it can be understood that the embodiments of the present disclosure may be practiced without these specific details. In some instances, well-known methods, structures, and technologies are not shown in detail, so as not to obscure the understanding of this specification.

Similarly, it should be understood that in order to simplify the present disclosure and help understand one or more of the various disclosed aspects, in the above description of the exemplary embodiments of the present disclosure, the various features of the present disclosure are sometimes grouped together into a single embodiment, figure, or its description. However, the disclosed method should not be interpreted as reflecting the intention that the claimed disclosure requires more features than those explicitly recorded in each claim. More precisely, as reflected in the following claims, the disclosure aspect lies in less than all the features of a single embodiment previously disclosed. Therefore, the claims following the specific embodiment are thus explicitly incorporated into the specific embodiment, wherein each claim itself serves as a separate embodiment of the present disclosure.

Those skilled in the art can understand that it is possible to adaptively change the modules in the device in the embodiment and set them in one or more devices different from the embodiment. The modules or units or components in the embodiments can be combined into one module or unit or component, and in addition, they can be divided into multiple sub-modules or sub-units or sub-components. Except that at least some of such features and/or processes or units are mutually exclusive, any combination can be used to compare all the features disclosed in this specification (including the accompanying claims, abstract and drawings) and any method or device thus disclosed. All processes or units are combined. Unless expressly stated otherwise, each feature disclosed in this specification (including the accompanying claims, abstract and drawings) may be replaced by an alternative feature providing the same, equivalent or similar purpose.

In addition, those skilled in the art can understand that although some embodiments herein include certain features included in other embodiments but not other features, the combination of features of different embodiments means that they are within the scope of the present disclosure and form different embodiments. For example, in the following claims, any one of the claimed embodiments can be used in any combination.

It should be noted that the above-mentioned embodiments illustrate rather than limit the present disclosure, and those skilled in the art can design alternative embodiments without departing from the scope of the appended claims. In the claims, any reference numbers placed between parentheses should not be constructed as a limitation to the claims. The word “comprising” does not exclude the presence of elements or steps not listed in the claims. The word “a” or “an” preceding an element does not exclude the presence of multiple such elements. The present disclosure can be realized by means of hardware including several different elements and by means of a suitably programmed computer. In the unit claims enumerating several devices, several of these devices may be embodied in the same hardware item. In the unit claims enumerating several devices, several of these devices may be embodied in the same hardware item. The use of the words first, second, and third, etc. do not indicate any order. These words can be interpreted as names.

1. A method for displaying entity-associated information based on an electronic book, comprising:
determining keywords contained in pages of the electronic book, each of the keywords indicating an entity;
displaying a search entrance element corresponding to each of the keywords, the search entrance element configured to trigger a search request and search information associated with the entity; and
in response to detecting the search request triggered through the search entrance element, acquiring the information associated with the entity based on the search request and displaying the information associated with the entity.

2. The method according to claim 1,
wherein the determining keywords contained in pages of the electronic book further comprises:
recognizing the keywords contained in original text of the electronic book, and
determining offset amount information corresponding to each of the keywords in the electronic book; and
wherein the in response to detecting a search request triggered through the search entrance element, acquiring the information associated with the entity based on the search request and displaying the information associated with the entity further comprises:
determining offset amount information associated with text content of the search entrance element,
determining a keyword corresponding to the search entrance element based on the offset amount information associated with the text content of the search entrance element, and
acquiring information that matches the keyword corresponding to the search entrance element.

3. The method according to claim 2,
wherein the information associated with the entity comprises a book type of information; and
wherein the acquiring information that matches the keyword corresponding to the search entrance element further comprises:
selecting at least one electronic book associated with the keyword from electronic books contained in a database based on at least one of a number of occurrences of the keyword in each of the electronic books or user interaction data associated with each of the electronic books, and
determining the book type of information that matches the keyword based on the selected at least one electronic book.

4. The method according to claim 2,
wherein the information associated with the entity comprises a chapter and paragraph type of information; and
wherein the acquiring information that matches the keyword corresponding to the search entrance element further comprises:
selecting at least one chapter or paragraph from chapters or paragraphs of the electronic book based on at least one of a number of occurrences of the keyword in the chapters of the electronic book, a number of occurrences of the keyword in the paragraphs of the electronic book, user interaction data associated with each of the chapters, or user interaction data associated with each of the paragraphs, and
determining the chapter and paragraph type of information that matches the keyword based on the selected at least one chapter or selected paragraph.

5. The method according to claim 2, wherein the recognizing the keywords contained in original text of the electronic book further comprises:
acquiring each of words contained in the original text of the electronic book and an initial word vector corresponding to each of the words;
acquiring each of word segmentations contained in the original text of the electronic book and an initial phrase vector corresponding to each of the word segmentations;
determining a semantic word vector corresponding to each of the words based on the initial word vector corresponding to each of the words and context information of each corresponding word in the original text;
determining a semantic phrase vector corresponding to each of the word segmentations based on the initial phrase vector corresponding to each of the word segmentations and context information of each corresponding word segmentation in the original text;
determining a first entity recognition result based on semantic word vectors corresponding to the words;
determining a second entity recognition result based on semantic phrase vectors corresponding to the word segmentations; and
recognizing the keywords contained in the original text based on the first entity recognition result and the second entity recognition result.

6. The method according to claim 2, wherein the recognizing the keywords contained in original text of the electronic book further comprises:
in response to determining that a recognized keyword is a person name type of keyword, acquiring a person search result corresponding to the recognized keyword;
determining whether the person search result contains birth and death date information;
remaining the person name type of keyword when the person search result contains the birth and death date information; and
deleting the person name type of keyword when the person search result does not contain the birth and death date information.

7. The method according to claim 1, wherein the displaying a search entrance element corresponding to each of the keywords further comprises:
performing annotation processing on each of the keywords according to annotation information, wherein the annotation information is displayed as the search entrance element corresponding to each of the keywords wherein the annotation processing comprises at least one of highlighting, adding an underline, or adding a hyperlink, and wherein the underline comprises a solid line and a dashed line.

8. The method according to claim 1,
wherein a response priority of the search entrance element is lower than a response priority of a preset interaction element, and wherein the preset interaction element comprises a line-type interaction element; and
wherein the in response to detecting the search request triggered through the search entrance element, acquiring the information associated with the entity based on the search request and displaying the information associated with the entity further comprises:
in response to detecting an interaction event that corresponds to the search entrance element, determining whether there is an overlap area between the search entrance element and the preset interaction element,
triggering the search request in response to determining that there is no overlap area between the search entrance element and the preset interaction element, and
triggering an interaction request corresponding to the preset interaction element in response to determining that there is the overlap area between the search entrance element and the present interaction element.

9. An electronic device, comprising: a processor, a memory, a communication interface and a communication bus, wherein the processor, the memory and the communication interface communicate with each other through the communication bus, wherein the memory is configured to store executable instructions that upon execution cause the processor to perform operations, the operations comprising:
determining keywords contained in pages of the electronic book, each of the keywords indicating an entity;
displaying a search entrance element corresponding to each of the keywords, the search entrance element configured to trigger a search request and search information associated with the entity; and
in response to detecting the search request triggered through the search entrance element, acquiring the information associated with the entity based on the search request and displaying the information associated with the entity.

10. The electronic device according to claim 9, wherein the operations further comprise:
recognizing the keywords contained in original text of the electronic book, determining corresponding offset amount information of each of the keywords in the electronic book;
determining offset amount information associated with text content of the search entrance element,
determining a keyword corresponding to the search entrance element based on the offset amount information associated with the text content of the search entrance element; and
acquiring information that matches the keyword corresponding to the search entrance element.

11. The electronic device according to claim 10, wherein the information associated with the entity comprises a book type of information associated with the keyword, and the operations further comprise:
selecting at least one electronic book associated with the keyword from electronic books contained in a database based on at least one of a number of occurrences of the keyword in each of the electronic books or user interaction data associated with each of the electronic books, and
determining the book type of information that matches the keyword based on the selected at least one electronic book.

12. The electronic device according to claim 10, wherein the information associated with the entity comprises a chapter and paragraph type of information, and the operations further comprise:
selecting at least one chapter or paragraph from chapters or paragraphs of the electronic book based on at least one of a number of occurrences of the keyword in the chapters of the electronic book, a number of occurrences of the keyword in the paragraphs of the electronic book, user interaction data associated with each of the chapters, or user interaction data associated with each of the paragraphs, and
determining the chapter and paragraph type of information that matches the keyword based on the selected at least one chapter or selected paragraph.

13. The electronic device according to claim 10 claim, wherein the operations further comprise:
acquiring each of words contained in the original text of the electronic book and an initial word vector corresponding to each of the words;
acquiring each of word segmentations contained in the original text of the electronic book and an initial phrase vector corresponding to each of the word segmentations;
determining a semantic word vector corresponding to each of the words based on the initial word vector corresponding to each of the words and context information of each corresponding word in the original text;
determining a semantic phrase vector corresponding to each of the word segmentations based on the initial phrase vector corresponding to each of the word segmentations and context information of each corresponding word segmentation in the original text;
determining a first entity recognition result based on semantic word vectors corresponding to the words;
determining a second entity recognition result based on semantic phrase vectors corresponding to the word segmentations; and
recognizing the keywords contained in the original text based on the first entity recognition result and the second entity recognition result.

14. The electronic device according to claim 10, wherein the operations further comprise:
in response to determining that a recognized keyword is a person name type of keyword, acquiring a person search result corresponding to the recognized keyword;
determining whether the person search result contains birth and death date information;
remaining the person name type of keyword when the person search result contains the birth and death date information; and
deleting the person name type of keyword when the person search result does not contain the birth and death date information.

15. The electronic device according to claim 9, wherein the operations further comprise:
performing annotation processing on each of the keywords according to annotation information, wherein the annotation information is displayed as the search entrance element corresponding to each of the keywords, wherein the annotation processing comprises at least one of highlighting, adding an underline, or adding a hyperlink, and wherein the underline comprises a solid line and a dashed line.

16. The electronic device according to claim 9, wherein a response priority of the search entrance element is lower than a response priority of a preset interaction element, and wherein the preset interaction element comprises a line-type interaction element,
and wherein the operations further comprise:
in response to detecting an interaction event that corresponds to the search entrance element, determining whether there is an overlap area between the search entrance element and the preset interaction element,
triggering the search request in response to determining that there is no overlap area between the search entrance element and the preset interaction element, and
triggering an interaction request corresponding to the preset interaction element in response to determining that there is the overlap area between the search entrance element and the present interaction element.

17. A non-volatile computer readable storage medium storing at least one executable instruction, wherein the executable instruction is configured to cause a processor to perform operations, the operations comprising:
determining keywords contained in pages of the electronic book, each of the keywords indicating an entity;
displaying a search entrance element corresponding to each of the keywords, the search entrance element configured to trigger a search request and search information associated with the entity; and
in response to detecting the search request triggered through the search entrance element, acquiring the information associated with the entity based on the search request and displaying the information associated with the entity.

18. (canceled)
